(19) United States
(12) Patent Application Publication
(10) Pub. No.: US 2011/0271651 A1
(43) Pub. Date: Nov. 10, 2011

(54) REMOVABLE TRACTION CONTROL SYSTEM, METHOD AND APPARATUS FOR EQUESTRIAN AND OTHER MOUNTABLE SPORTS RIDING EQUIPMENT

(76) Inventor: LEEANN MORGAN, Santa Barbara, CA (US)

(21) Appl. No.: 12/983,625

(22) Filed: Jan. 3, 2011

Related U.S. Application Data
(60) Provisional application No. 61/291,883, filed on Jan. 2, 2010.

(51) Int. Cl. B68C 1/02

(52) U.S. Cl. 54/44.1

(57) ABSTRACT

A System, Method and Apparatus for non-permanent traction control on equestrian or other mountable riding equipment is provided. The system comprises 1-6 thin, cushioned, traction control or grip-increasing panels that, when deployed on a riding saddle or other mountable object for human sport riding, creates traction and dissipates excessive motion, percussion and shock generated by the motion of animal, simulated animal or other motorized sport-riding object. The System's parts are applied to any surface involved in creating an improved non-slip interface between the rider and the mounted saddle or other sports riding equipment, or as a contact-improving fitting shim between the saddle and the object onto which the saddle is attached.

This invention references and claims benefit of the U.S. Provisional Application No. 61/291,883, Removable Traction Control Pad System, Method and Apparatus for Equestrian Riding Saddles, Filed by Lee Ann Morgan, Customer # 89524.

### FIELD OF THE INVENTION

### Equestrian and Other Mounted Riding Sports

This invention relates to a removable traction control System for increasing traction at the interfaces between a rider and the saddle of a mountable animal or object.

The inventive System, Method, and Apparatus encompassed, claimed and taught herein is to be classified as a Sporting Goods object relating to Equestrian or other mounted-types of riding sport, whether animal or non-animal.

The Traction Control System can be rendered from any suitable traction-causing material subject to change with evolving developments in applied materials research science, manufacturing and production technology.

This application does not teach or claim to be a new material, nor does it encompass any abstract property of traction control in general, nor does it attempt to improve upon any general gripping property inherent in any prior art application set forth by any previously claimed single material's conception or design. (e.g. Kobe 2003).

### BACKGROUND OF THE INVENTION

### History, Problem Statement

In equestrian sport, riding safety and performance largely depend on the rider's grip upon the saddle of the animal.

Conventional riding saddles, made from leather, synthetic leather, or nylon-composite fabric (Wintec Saddle Company), while durable, are not particularly safe and often do not afford the rider the best traction needed for optimal control during higher-speed motion, in response to sudden movements of the animal over difficult terrain, or in making high-precision turns or jumps during the ride. Constant and prolonged use of the rider's leg and back muscles requires extensive strength, coordination and endurance—often more than the rider possesses, and results in undue fatigue, creating safety risks, incorrect signals to the horse, major bodily injury from rider falls and other detriments such as in loss of balance, over-corrections, reduced precision during competition, and other injury accidents. Also, saddles are expensive pieces of equipment in all Equestrian sport. While the internal structure of a conventional saddle remains sturdy over time, the surface areas which contact the rider eventually succumb to weathering, slickening of the leather surface, stitching breakage, and general wear and tear, decreasing the lifespan and safe usage of the saddle. Lastly, saddles are designed and mass-manufactured in a universal, general shape of a horse's back and the rider's lower body in their geometry, and therefore often do not fit a specific rider or horse as they should. this causes soreness and lameness for both horse and rider.

### SUMMARY OF THE INVENTION

### Solution, General Properties

The present invention is a Traction Control System for Equestrian and other non-equestrian Riding Saddles or mountable sports equipment—a system of up to 6 removable traction panels that non-permanently attach to and remove from the contact surfaces of riding equipment, improving the rider's grip and safety, and adding customized, continually adjusting contact between rider and mounted object. The inventive Removable Traction & Saddle Fitting System components are comprised of any suitable traction-enhancing and shock-absorbing material, of co-bonded and/or moulded layers of current (or future) natural or synthetic rubber compounds, gels, foams, co-polymers, waxes and adhesives, that can be removed, repositioned, cleaned and re-applied when the rider so desires.

When applied to a riding saddle, the inventive System pieces can be applied to any rider-contact interface of the saddle, or to the undersides of the saddle (the interface between the saddle and the mounted animal or object. In one embodiment, the Removable Traction Control panels are positioned on an Equestrian saddle where the saddle's surface contacts the seat, knee, and calf areas of the rider's body.

While the Inventive Traction Control System allows for greater amounts of grip and control for the rider when exerting muscle pressure on the animal or mounted object when called for, the system also provides for subtle adjustments to and an effortless release of the rider's seat and legs over the traction control system's surface; this easy-release quality is an important attribute of enhanced traction control while mounted on a moving animal or object. The grasp-and-release sensation for the rider during use is similar to the feeling of grasping and letting go of a sports racquet handle having a cushioned, synthetic, rubberized, textured grip with a thin foam core. When the rider re-applies muscle pressure, optimum hold is again achieved.

### BRIEF DESCRIPTION OF THE DRAWINGS

The above features of the present invention become more apparent by reference to the following descriptions of the accompanying drawings labeled FIGS. 1-6.

FIG. 1 is a schematic of an English-type riding saddle Traction Control System according to one embodiment of the present invention;

FIG. 2 is an exploded elevational view of one side of an English-type riding saddle incorporating the Equestrian Saddle Traction Control System of FIG. 1 and applied to the saddle;

FIG. 3 is a top view of the seat component of the saddle of FIGS. 1 and 2;

FIG. 4 is a schematic of a Western-type riding saddle Traction Control System according to a second Equestrian embodiment of the present invention;

FIG. 5 is an exploded elevational view of one side of the Western-type Equestrian saddle incorporating the Saddle Traction Control System of FIG. 4 as applied to the saddle;

FIG. 6 is a top view of the seat of the Western Saddle of FIGS. 4 and 5.

### DETAILED DESCRIPTION OF THE INVENTION

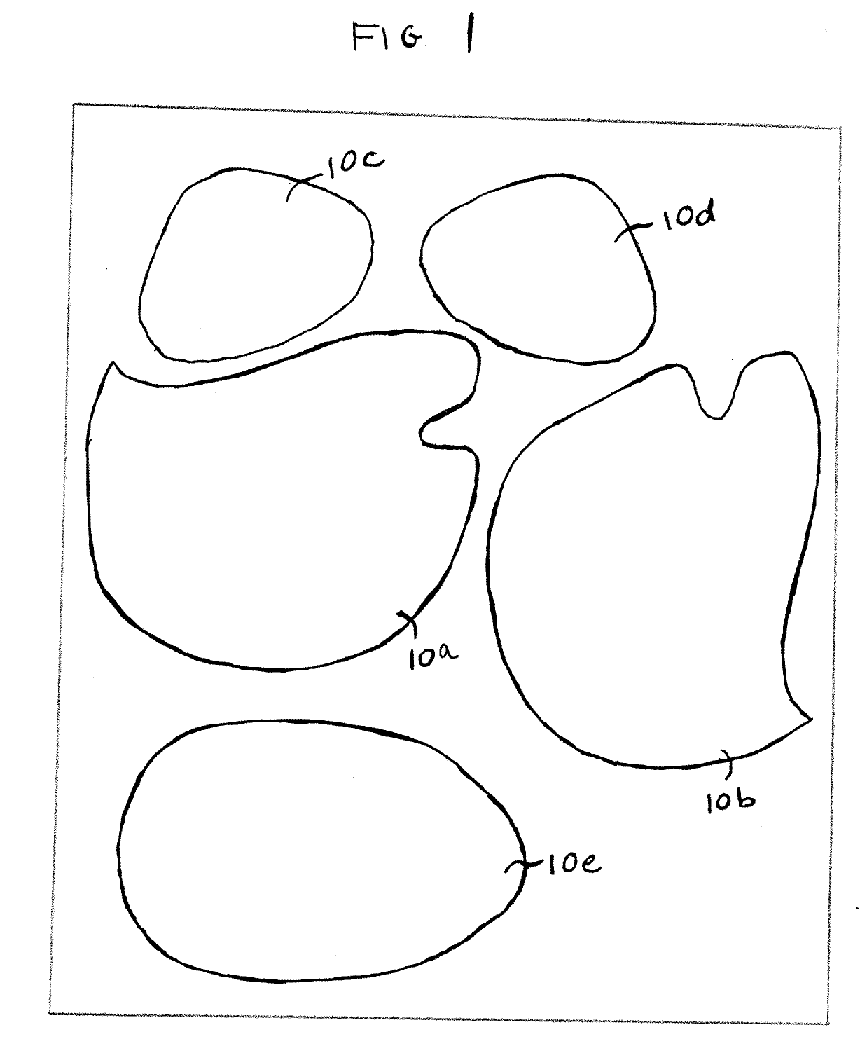

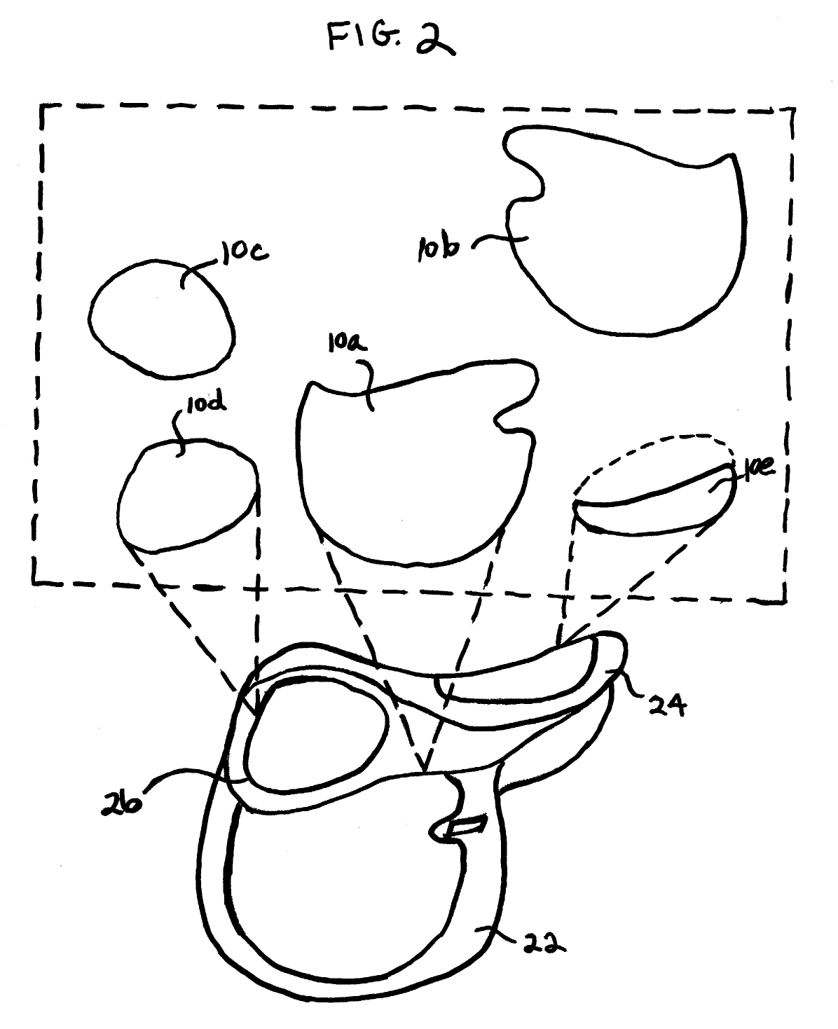

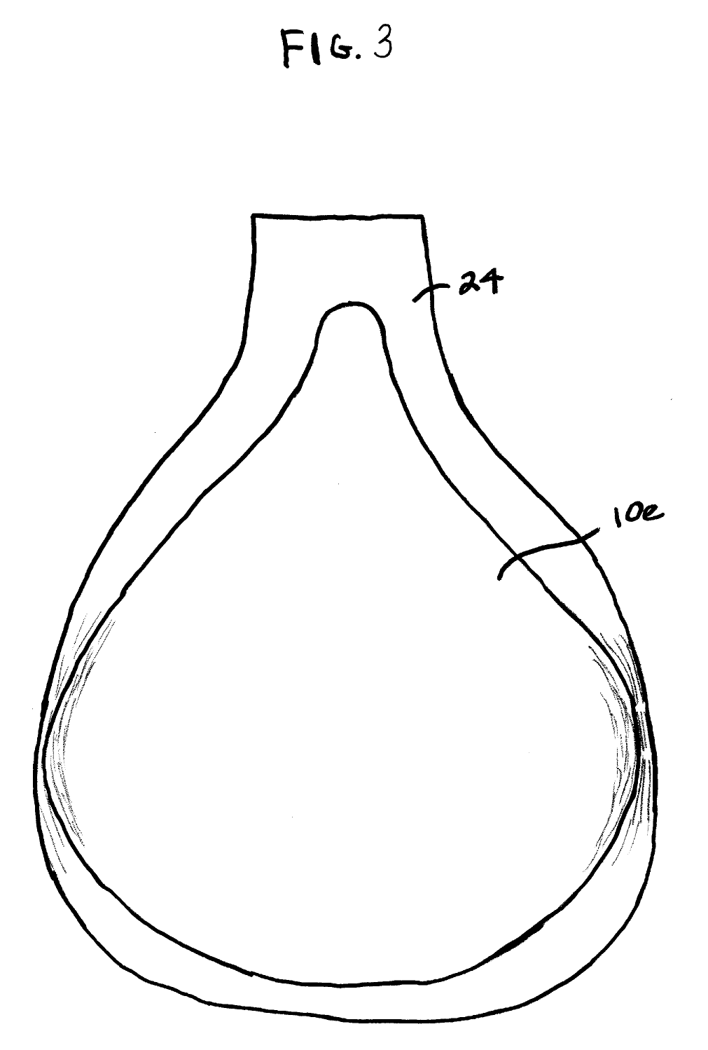

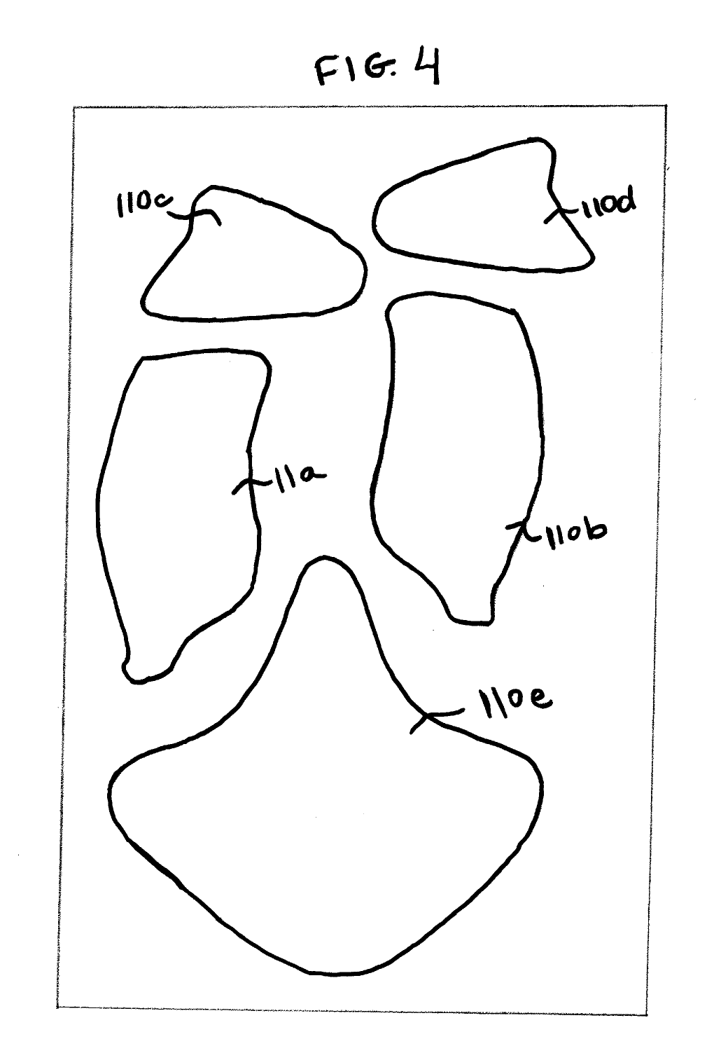

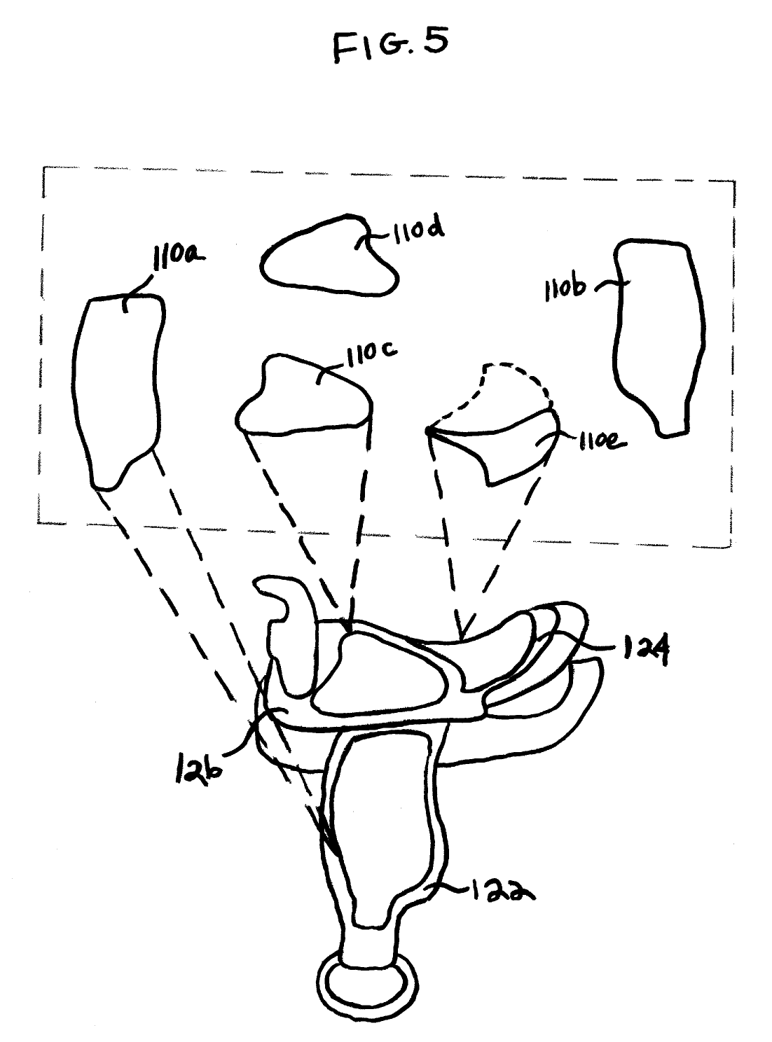

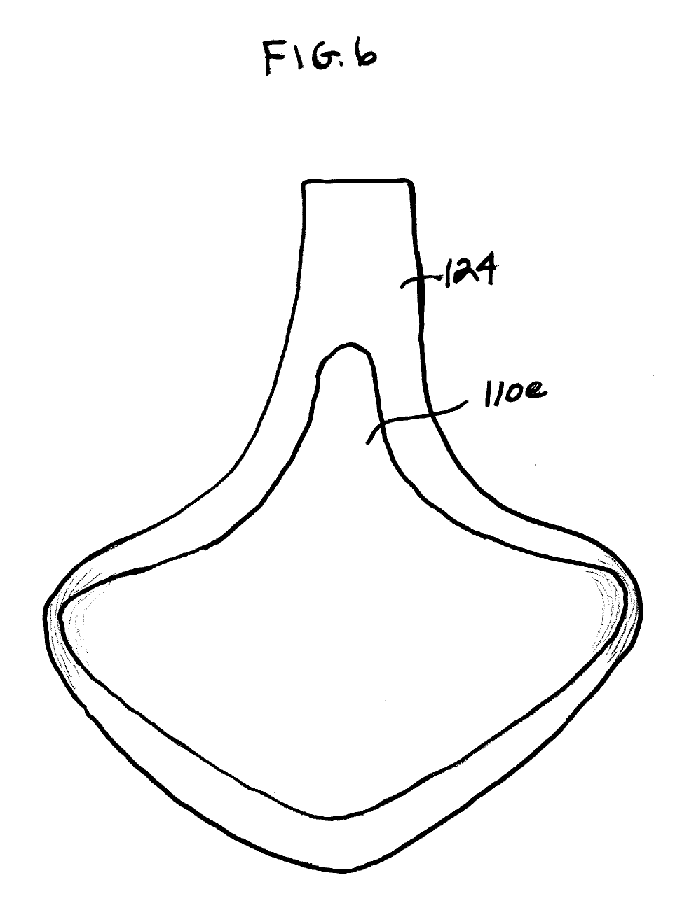

As shown in FIGS. 1-6, a Traction Control System whose individual panels are shaped according to each of the 2 embodiments of the present invention—an English-type Saddle (FIG. 1.10b-e, FIG. 2.10a-e, and FIG. 3.10e), and a Western-type Saddle (FIG. 4.110a-e, FIGS. 5.110a-e and 6.110e). The System comprises up to 6 pieces that are properly sized and shaped to apply to the Saddle and to contact the rider's anatomy for optimized control and performance.

The minimum and maximum effective size for each of the various panels in the Traction Control System is variable, depending on the size and shape of the saddle and the rider (adult or child), but is approximately similar to the size in square inches/centimeters of the involved anatomical contact areas of the rider's body that require the Traction of the System. Each piece of the current System can range from 7″×9″, to 8″×10″, but can be modified either by the designer in response to market demand or the user. For example, the current total number of square inches of material for the English Saddle Traction Control Pad System is approximately 180-240 Square Inches.

The separate pieces of the Traction Control Pad System are each fabricated from any suitable current or evolving traction-causing material, compound or copolymer; e.g. Ethyl Vinyl Acetate (EVA) foam, Tri-poly Ethylene (TPE) and Polyurethane Gel (PU Gel), and may have an exposed rider contact surface that is smooth, textured, embossed with graphics and/or tread pattern, indentations, bumps or striations. Any other natural or synthetic rubberized compound, whether petroleum, vegetable, or silicone based, can be used, whose method of manufacture is die-cut, heat-moulded, pressure-extruded, steel-cast or compression formed.

As shown in FIG. 2.10a-e, the Pieces (Panels) of the Traction Control Pad System are positioned on the rider contact portions of an English saddle (FIG. 2.20), those being the Seat (FIG. 2.24), the Left Side Skirt (FIG. 2.26), and the Left Leg Flap (FIG. 2.22). FIG. 3.10e shows an overhead view of the seat piece of the System as positioned on the seat (FIG. 3.24) of an English Saddle.

FIG. 5.110a-e show the Traction Control Pad System's pieces as positioned on a Western-type Saddle (FIG. 5.120). In this embodiment, the Pommel Pieces (FIG. 5.110c-d) of the System, are positioned over the left and right sides of the front (Pommel) of the Western Saddle. FIG. 4.110e and FIG. 5.110e show the seat piece of the Traction Control System as being positioned over the Cantle, (FIG. 5.124) which comprise the seat and rear edge-portions of the Western Saddle.

In the current claimed embodiments of the invention, the System's material can have a minimum effective thickness of 1/16″, and a maximum of 8/16″; however, that can vary, depending on the aptitude level of the rider and the particular demands of the riding discipline for which it is intended.

For both of the current embodiments, Custom-requested shapes can be tooled on request.

The pieces for the English and Western Saddle Traction Control Systems (FIGS. 2, 5) can also be modified by the rider with scissors, and applied to the underside portions of the saddle that contact the horse to provide further stability, fit, and cushioning of the saddle upon the horse.

The following general underside parts of the saddle, as described below, shelter the horse's spinal column between the thoracic and lower cervical vertebrae, the shoulders, and the rib cage:

1) the twin panels running along either side of the horse's thoracic spinal vertebrae;
2) the panels that run down each of the two front shoulder sections of the saddle;
3) the smaller under-flaps, set under the outer leg flaps of the saddle, that protect the horse's rib cage.

When used on an Equestrian Saddle the inventive Traction Control System can be sized, shaped and placed anywhere suitable for increasing the rider's grip. Such a Traction Control System provides the rider with additional grip that the saddle alone, as manufactured, does not provide. The inventive Traction Control System affords the rider improved motion response and decreased muscle fatigue, thus increasing riding safety, performance, and comfort.

Although presently illustrated and described in connection with English and Western-type Saddles, it is understood that the Traction Control System of the Equestrian Saddle embodiment can be used with any type of riding saddle design—including but not limited to Australian Outback, Polo, Dressage, Racing, and Treeless Saddle designs, as well as on Bareback Riding Pads and Equestrian Vaulting Platforms. The Traction Control System can also be applied directly to the horse or animal, and used for riding without a saddle, such as in Professional Rodeo Bareback Horse and Bull Riding Competitions.

Maintaining sustained grip for extended time periods during riding is difficult, as the animal shifts horizontally, vertically, and side to side, accelerating and decelerating, depending on the demands called for by the particular riding Discipline in which the rider is engaged. Constant motion of the rider against the saddle also creates an abrasive condition between the rider's skin and clothing in the areas of contact, and the Traction Control System of the current invention, in providing greater hold, cushioning and stability to the rider, also reduces the occurrence of “saddle sores” in the areas of the rider's seat, knees, and legs that contact the saddle.

Additionally, the Traction Control System's material composition also has a cushioning element that dampens the effects of excessive motion generated by the animal, creating a more solid sense of feel between the rider and the ground.

The inventive Traction Control System is also designed for Extreme Competition-Level Equestrian Sports such as Steeple-Chasing, Polo, 3-Day Eventing, and Film Stunt Riding.

### CONCLUSION

The preceding descriptions of the Removable Traction Control Pad System have been presented with reference to certain Equestrian Saddle embodiments of the current invention. However, workers and craftsmen skilled in the Equestrian art and technology to which this invention pertains will appreciate that alterations and changes to the described embodiments in response to market demands may be practiced without meaningfully departing from the principal, spirit, and scope of this invention. Accordingly, the foregoing description should not be read as pertaining only to the precise embodiments described and illustrated in the included drawings, but rather should be interpreted as consistent with and as support for the claims stated at the beginning of this Application, which are to have their fullest and fairest scope.

1. Rider's Contact Surfaces:
A Removable System, Method and Apparatus for improving traction and fit to the topside (rider's) contact surface of equestrian riding saddles or other mountable sports riding equipment comprising: up to 6 thin, flexible, grip-improving panels that, deployed in unison, increase the Rider's grip upon the riding saddle of a mounted animal or other non-animal sports riding object; wherein each piece in the system is made from synthetically fabricated materials, is sized and shaped to create a proportional, continually adjusting, dynamic (i.e. hold-and-release) pressure-sensitive gripping interface between the surfaces of a riding saddle for a mounted animal or non-animal sports object or motorized/robotically controlled sports simulation device, and the related seat and leg portions of the rider's body, and wherein each piece is comprised of material having an optimal thickness (gauge) range of 1/16″ to 10/16″, which includes a surface traction control property that contacts the rider, a central cushioning property (such as gel or foam), and a temporary, non-damaging (“fugitive”) adhesive property contact that temporarily adheres to the equestrian saddle or other mountable sports object for riding, (e.g. motorcycle, mechanical bull, mechanical horse simulator.)

2. Underside of Saddle:
The Traction Control System of claim 1, wherein the proportioned and interdependent pieces of the System can be applied to any or all of the undersides of an Equestrian or other Sports Equipment Saddle, forming a cushioned, continually adjusting, high-traction, fit-improving, protective removable interface between the saddle or other riding/harnessing equipment's underside and the natural anatomic flexion of the underlying skin, muscle and connective tissues of the animal, resulting in better equipment fit to the animal's variable anatomy during motion, in shock-absorbing dynamic under the rider, and general balance for the animal in relation to the rider, and in preventing unnecessary muscle soreness and lameness to the animal caused by the rider.

3. Equestrian or other mountable Riding/Sports Equipment Saddles in General:
The Traction Control System of claim 1, wherein each Removable piece (panel) of the System is sized and shaped to correlate to the various components of any Riding Saddle attached to a mounted object, that contacts the rider's seat, pelvis, thighs, and calves, for increased control of the mounted object and reduction of injury or other detriment to the rider.

4. Equestrian Saddle or Motorsports equipment Specific Components:
The Traction Control System of claim 3, wherein the panels are sized and shaped to fit the portions of the saddle that are selected from the group consisting of the seat, pommel, cantle, side skirt, stirrup bar flap, knee roll, side jockey, leg flap or underside of same, inner flap or underside of same, fender or underside of same, thigh block, calf block, spine panel, shoulder panel, vaulting platform, harness, gas tank or any other underside (animal contact) surface of riding equipment used on an animal.
